(19) United States
(12) Patent Application Publication
(10) Pub. No.: US 2015/0105497 A1
(43) Pub. Date: Apr. 16, 2015

(54) INORGANIC FILLER COATED WITH MOLYBDENUM COMPOUND AND USAGE THEREOF

(71) Applicant: NAN YA PLASTICS CORPORATION, Taipei (TW)

(72) Inventors: Dein-Run FUNG, Taipei (TW); Te-Chao LIAO, Taipei (TW); Hao-Sheng CHEN, Taipei (TW); Chun-Lai CHEN, Taipei (TW)

(21) Appl. No.: 14/503,536

(22) Filed: Oct. 1, 2014

(30) Foreign Application Priority Data
Oct. 11, 2013 (TW) 102136701

(51) Int. Cl. C08K 3/22; C08K 3/36

(52) U.S. Cl. CPC C08K 3/22; C08K 3/36; C08K 2003/2255
USPC 523/458; 106/479

(57) ABSTRACT

An inorganic filler coated with molybdenum compound used as an additive is added into a resin mixture in an amount of 20 to 80 wt % of the resin mixture, resulted in that printed circuit boards if made from a laminate or a prepreg containing the resin mixture have properties of a low coefficient of thermal expansion, good heat tolerance and excellent drilling processability.

### BACKGROUND OF THE PRESENT INVENTION

1. Field of the Invention

The present invention relates to an inorganic filler with its surface having been modified, and more particularly to an inorganic filler coated with a molybdenum compound, which is suitable for making printed circuit boards that has a low coefficient of thermal expansion, good heat tolerance, and excellent drilling processability.

2. Description of Related Art

With the trend of making electronics light, compact and versatile, printed circuit boards (hereinafter referred to as PCB(s)) have been required to have high density and provide high transmission/processing performance. For meeting such requirements, PCBs are now produced by stringent specifications about rigidity, the coefficient of thermal expansion and heat tolerance.

In the current technology, for making PCBs capable of exhibiting good rigidity, heat tolerance and dimensional stability, and having a low coefficient of thermal expansion, it is a conventional practice to add a certain amount of inorganic filler(s) into the epoxy-based formula for forming substrates for PCBs. The most commonly used inorganic filler is silicon dioxide (SiO₂).

However, silicon dioxide has a Mohs hardness as high as 7.0, being unfavorable to the desirable drilling processability of PCBs. During the drilling process of PCBs, silicon dioxide can wear the drill bit heavily, thus being related to the disadvantages involving frequent need for replacing or sharpening drill bits, inferior hole-drilling quality that leads to poor electric properties of the resulting PCBs, high manufacturing costs and low yield.

For improvement in PCBs with excellent drilling processability, known prior arts have discussed some relevant technologies opened to public.

Japanese Patent Publication No. 2005-162787 discloses to have platelet calcined talcum added as an inorganic additive (of a Mohs hardness of 1.0 to 1.5), or have calcined talcum added in a reduced amount. However, the result of no improvement in PCBs' drilling quality is observed, and it even causes PCB to possess adverse properties such as negative in rigidity, coefficient of expansion and dimensional stability.

Japanese Patent Publication No. 2011-137054 on the other hand proposes to allow molybdenum compound particle as an additive added into the conventional resin formula, yet the additive of molybdenum compound particle makes the resulting copper substrate to decrease in heat resistance.

### SUMMARY OF THE INVENTION

For addressing the problems mentioned above, the primary objective of the present invention is to provide a kind of inorganic filler having a molybdenum-compound coating, and the inorganic filler has a core-shell structure having an average particle size between 0.01 and 50 μm in diameter and further comprising an inorganic particle formed as a core and a molybdenum-compound coating formed as a shell covered over the inorganic particle. The molybdenum-compound coating contains a molybdenum compound having a coating load of 0.01 to 5 wt %, preferably 0.1 to 3 wt %, of the inorganic filler. In particular, the molybdenum compound is an ammonium phosphomolybdate or a crystal-water-containing molybdenate having a chemical formula (I) as follows:

xMe₂O.yMoO₃.nH₂O (I)
where, Me is selected from the group consisting of sodium (Na), ammonium (NH₄), barium (Ba), ferrum (Fe), lead (Pb) and copper (Cu);
x:y=1:1; 1:2; 1:3; 1:4; 1:10; 1:16; 3:7; 3:8 or 5:12;
n is an positive integer from 1 to 10.

The inorganic particle forming the core may be spherical or irregular, and is one or more selected from the group consisting of silicon dioxide (in a melted or non-melted stat), titanium dioxide, aluminum hydroxide, magnesium hydroxide, calcium carbonate, aluminum oxide, magnesium oxide, talcum, aluminum nitride, boron nitride, silicon carbide, zinc oxide, zirconium oxide, quartz, diamond powder, diamond-like powder, graphite, calcined kaolin and fumed silica.

Another primary objective of the present invention is to provide a laminate or a prepreg for use in making a PCB, wherein the composition of the laminate or the prepreg comprises a resin mixture containing the inorganic filler mentioned above in an amount of 20 to 80 wt % of the resin mixture, and the PCBs made from the laminate or the prepreg have properties of a low coefficient of thermal expansion, good heat tolerance and excellent drilling processability.

### BRIEF DESCRIPTION OF THE SEVERAL VIEWS OF THE DRAWINGS

FIG. 1 is an image of a drill bit before used for drilling.

FIG. 2 is an image of the drill bit of FIG. 1 after drilling 2,000 holes on laminates of Embodiment 1.

FIG. 3 is an image of the drill bit of FIG. 1 after drilling 2,000 holes on laminates of Embodiment 2.

FIG. 4 is an image of the drill bit of FIG. 1 after drilling 2,000 holes on laminates of Embodiment 3.

FIG. 5 is an image of the drill bit of FIG. 1 after drilling 2,000 holes on laminates of Embodiment 4.

FIG. 6 is an image of the drill bit of FIG. 1 after drilling 2,000 holes on laminates of Embodiment 5.

FIG. 7 is an image of the drill bit of FIG. 1 after drilling 2,000 holes on laminates of Embodiment 6.

FIG. 8 is an image of the drill bit of FIG. 1 after drilling 2,000 holes on laminates of Comparative Example 1.

FIG. 9 is an image of the drill bit of FIG. 1 after drilling 2,000 holes on laminates of Comparative Example 2.

FIG. 10 is an image of the drill bit of FIG. 1 after drilling 2,000 holes on laminates of Comparative Example 3.

FIG. 11 is an image of the drill bit of FIG. 1 after drilling 2,000 holes on laminates of Comparative Example 4.

FIG. 12 is an image of the drill bit of FIG. 1 after drilling 2,000 holes on laminates of Comparative Example 5.

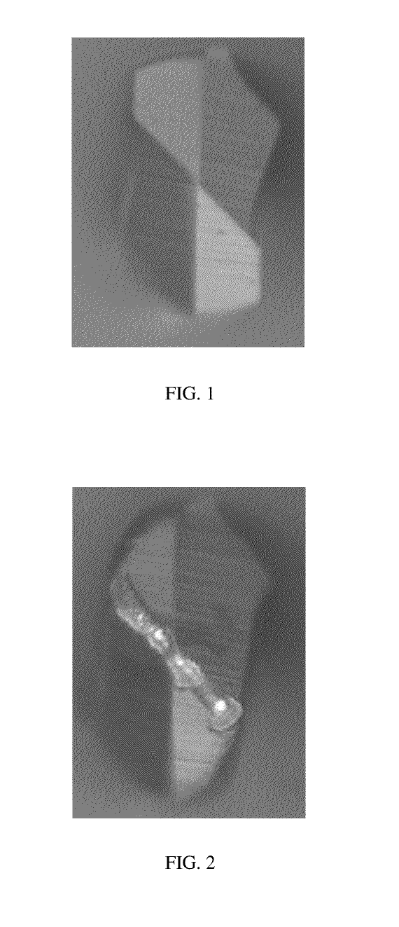

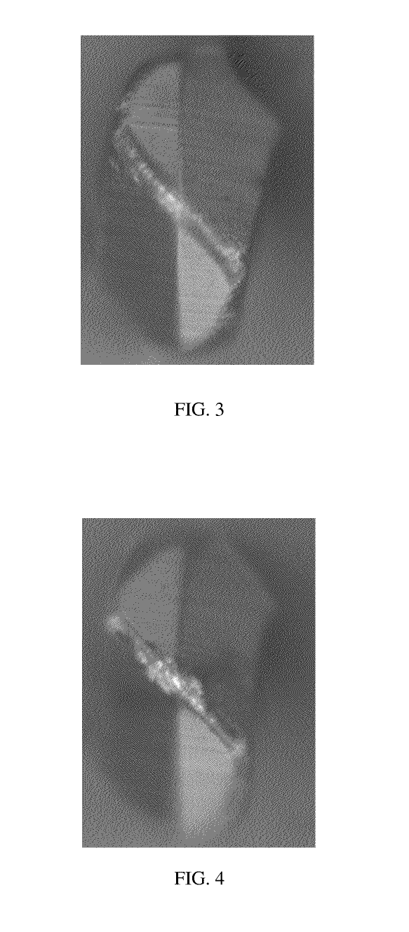

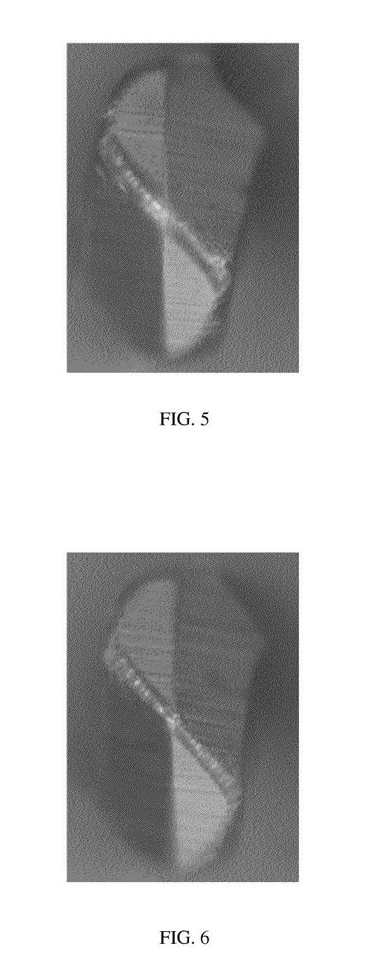

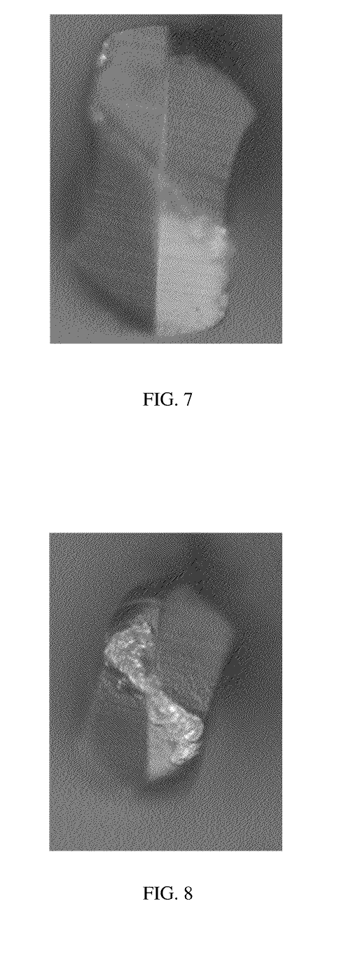

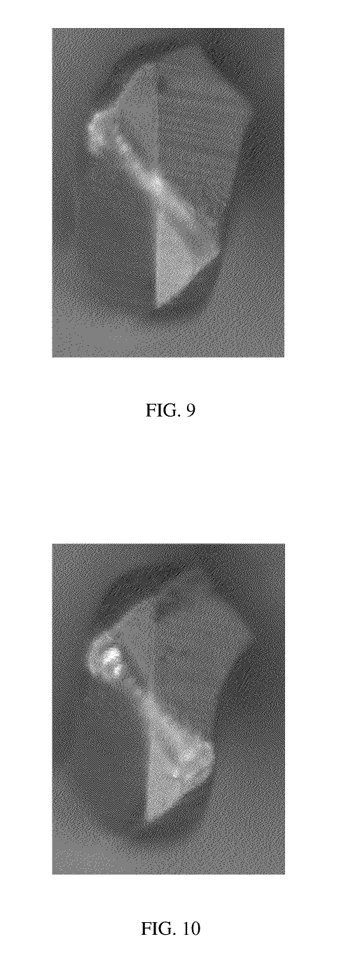

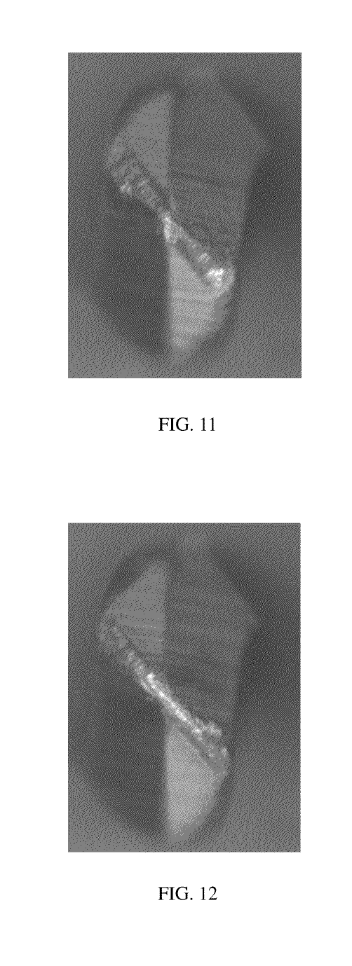

### DETAILED DESCRIPTION OF THE INVENTION

Based to the known technology, as the content of inorganic fillers in a printed circuit board (PCB) increases, the PCB's coefficient of thermal expansion and hole-drilling quality decreases.

An inorganic filler coated with a molybdenum compound according to the present invention (hereinafter referred to as the disclosed inorganic filler) is a kind of inorganic filler having its surface modified with molybdenum compound. The disclosed inorganic filler used as an additive is added into a resin mixture in an amount of 20 to 80 wt % of the resin mixture. And, the resin mixture is further prepared for use in making a laminate or a prepreg.

A PCB if made from the laminate or prepreg of which composition contains the disclosed resin mixture shall possess effective properties including a lower coefficient of thermal expansion, a good heat tolerance and an excellent drilling processability. Accordingly, In the course of making the PCB, the drilling precisions as well as the solder heat resistance of the PCB are both outstandingly improved.

The resin mixture containing the disclosed inorganic filler is ranged between 20 wt % and 80 wt % and suited for use in making the laminate or prepreg. The inorganic filler is contained in the resin mixture if less than 20 wt % thereof, the result PCB cannot have a significantly lower coefficient of thermal expansion, while if more than 80 wt % thereof, it degrades the prepreg's processability during impregnation.

The disclosed inorganic filler has an average particle size between 0.01 and 50 nm in diameter, which structural composition is a core-shell structure including an inorganic particle formed as a core and a molybdenum compound coating formed as a shell covered over the surface of the inorganic particle.

The molybdenum-compound coating contains a coating load of molybdenum compound of 0.01 to 5 wt %, preferably 0.1 to 3 wt %, of the inorganic filler. The coating load of molybdenum compound is contained in the molybdenum-compound coating if less than 0.01 wt % thereof, the inorganic filler would be incompetent to meaningfully improve the drilling processability of the resulting PCB, or if more than 5 wt % thereof, the resulting PCB would have decreased in heat resistance.

The inorganic particle formed as the core may be spherical or irregular and is one or more selected from the group consisting of silicon dioxide (in a melted or non-melted state), titanium dioxide, aluminum hydroxide, magnesium hydroxide, calcium carbonate, aluminum oxide, magnesium oxide, talcum, aluminum nitride, boron nitride, silicon carbide, zinc oxide, zirconium oxide, quartz, diamond powder, diamond-like powder, graphite and calcined kaolin.

The inorganic particle formed as the core may be alternatively nano-sized porous silicon. In this case, the porous silicon is preferably fumed silica having an average particle size between 1 and 100 nm, and added in an amount of 0.1 to 10 wt %. Where the proportion of the fumed silica is more than 10 wt %, the resulting resin mixture would be too viscous to allow smooth processing.

The molybdenum-compound coating formed as the shell is composed of ammonium phosphomolybdate ((NH₄)₃{P(Mo₃O₁₀)₄}.6H₂O) or a crystal-water-containing molybdenate having a chemical formula (I) as follows:

xMe₂O.yMoO₃.nH₂O (I)
where,
   Me is metal, and is selected from the group consisting of sodium (Na), ammonium (NH₄), barium (Ba), ferrum (Fe), lead (Pb) and copper (Cu);
   x:y=1:1; 1:2; 1:3; 1:4; 1:10; 1:16; 3:7; 3:8 or 5:12;
   n is an positive integer from 1 to 10.

Generally, a salt with x:y=1:1 is referred to as orthomolybdate; a salt with x:y=1:2 is referred to as dimolybdate; a salt with x:y=3:7 or 5:12 is referred to as paramolybdate; a salt with x:y=1:3 or 1:4 is referred to as metamolybdate; a salt with x:y=3:8 is referred to as octamolybdate; a salt with x:y=1:10 is referred to as decamolybdate; a salt with x:y=1:16 is referred to as hexadecamolybdenate. Therein, n is an integer from 1 to 10. That means the molybdenate contain crystal water, which improves the water suitability, thereby facilitating subsequent modification of the inorganic filler.

The crystal-water-containing molybdenate having chemical formula (I) includes: orthomolybdate (Me₂O.MoO₃.nH₂O), dimolybdate (Me₂O.2MoO₃.nH₂O), paramolybdate (3Me₂O.7MoO₃.nH₂O), paramolybdate (5Me₂O.12MoO₃.nH₂O), metamolybdate (Me₂O.3MoO₃.nH₂O), metamolybdate (Me₂O.4MoO₃.nH₂O), octamolybdate (3Me₂O.8MoO₃.nH₂O), decamolybdate (Me₂O.10MoO₃.nH₂O), and hexadecamolybdenate (Me₂O.16MoO₃.nH₂O).

In chemical formula (I), Me is a metal, and may be sodium (Na), ammonium (NH₄), barium (Ba), ferrum (Fe), lead (Pb) or copper (Cu). For ensuring the water suitability of the molybdenate during subsequent modification, Me is preferably sodium or ammonium.

Where Me in chemical formula (I) is sodium (Na), the chemical formula is xNa₂O.yMoO₃.nH₂O, including sodium molybdate when x:y=1:1 and sodium dimolybdate when x:y=1:2; sodium paramolybdate when x:y=3:7 or 5:12; sodium metamolybdate when x:y=1:3 or 1:4; sodium decamolybdate when x:y=1:10; and sodium hexadecamolybdenate when x:y=1:16, wherein n is an integer between 1 and 10.

Where Me in chemical formula (I) is ammonium (NH₄), the chemical formula is

x(NH₄)₂O.yMoO₃.nH₂O, including ammonium molybdenum when x:y=1:1; ammonium dimolybdate when x:y=1:2; ammonium paramolybdate when x:y=3:7 and 5:12; ammonium octamolybdate when x:y=3:8; ammonium metamolybdate when x:y=1:3 or 1:4; ammonium decamolybdate when x:y=1:10; and ammonium hexadecamolybdenate when x:y=1:16, where n is an integer between 1 and 10.

For making the disclosed inorganic filler, a coupling agent may be added as a surface treating agent when the molybdenum compound is applied for coating. The coupling agent may be one or a combination of two or more selected from silane coupling agents, titanate coupling agent or phosphatecoupling agent. Therein, the silane coupling agent may be vinyl trichlorosilane, vinyl trimethoxy silane, vinyl trimethoxy silane, beta-(3,4-epoxycyclohexyl) ethyl trimethoxy silane, 3-(glycidoxypropyl)trimethoxy silane, 3-(glycidoxypropyl) dimethylethoxy silane, 3-glycidyloxypropyl triethoxy silane, p-isobutene trimethoxy silane, 3-isobutene propyl methyl dimethoxy silane, 3-isobutene propyl trimethoxy silane, 3-isobutene propyl triethoxy silane, 3-isobutene propyl methyl dimethoxy silane, 3-acrylic propyl trimethoxy silane, N-2(amino ethyl)3-amino propyl methyl dimethoxy silane, N-2(amino ethyl)3-amino propyl trimethoxy silane, N-2(amino ethyl)3-amino propyl triethoxy silane, 3-amino propyl trimethoxy silane, 3-amino propyl triethoxy silane, N-phenyl-3-amino propyl trimethoxy silane, 3-amyl-N-(1,3-dimethyl-butylene)propyl triethoxy silane, 3-sulfhydrylpropyl methyl dimethoxy silane, 3-sulfhydrylpropyl trimethoxy silane or 3-isocyanatopropyl triethoxy silane. These coupling agents may be used separately or as a combination of two or more of them.

For making the disclosed inorganic filler, the process of coating the inorganic filler covered with the molybdenum compound may be performed using a dry method and a wet method.

In the dry method, a modified mixing machine is used for modification. Firstly, a proper amount of the molybdenum compound is dissolved in water, and applied using a special nozzle (providing a liquid drop smaller than 0.2 μm) at the room temperature to the surface of the inorganic filler evenly. During the spraying process, the inorganic filler particles are stirred in the mixing machine, so as to achieve uniform coating. After the solution of the molybdenum compound is applied, the particles are stirred for 2 to 4 more hours. Then the processing temperature is increased to 120° C. and the stirring is continued for 2 to 4 more hours. Afterward, the residual water is dried by heat, and the inorganic filler coated with the molybdenum compound in a dry manner is obtained.

In the wet method, a proper amount of the molybdenum compound is dissolved in water first, and the inorganic filler particles are added in a proper proportion so that the inorganic filler particles contribute a 20% solid content in the solution. The mixture is mixed for 2 to 4 hours at 80° C. and then filtered. The filtered inorganic filler particles are dry at 120° C. for 2 to 4 hours, and the inorganic filler coated with the molybdenum compound in a wet manner is obtained.

The disclosed inorganic filler obtained from either of the above methods is suited for making various laminates and various electronic products. For the disclosed inorganic filler to add, the resin mixture for use in making laminates is not limited. Compared with laminates made without adding the inorganic filler, the laminate having the disclosed inorganic filler is significantly improved in terms of drilling processability.

### Embodiment 1

First, sodium molybdate (Na₂MoO₄.2H₂O) in an amount of 0.3 parts by weight was dissolved in 300 parts by weight of water. The solution was applied using a special nozzle (providing a liquid drop smaller than 0.2 nm) at the room temperature to 300 parts by weight of silicon dioxide particles (supplied by Admatechs, Product Code SC2500). During the spraying process, the inorganic filler was mixed by a mixing machine for even coating. After the spraying process ended, the mixing was continued for 2 to 4 hours. Then the processing temperature was increased to 120° C. and the mixing was performed for 2 to 4 more hours. Afterward, the residual water was dried by heat, and the silicon-dioxide-based inorganic filler coated with sodium molybdate was obtained, hereinafter referred to as Modified Filler A.

100 parts by weight of multifunctional epoxy resin (supplied by Nan Ya Plastics Corp. (hereinafter referred to as “NAN YA”) containing 30 parts by weight of NPPN-433 benzaldehyde-type phenolic epoxy resin, 30 parts by weight of NPPN-438 bisphenol-A-type phenolic epoxy resin, 20 parts by weight of NPPN-454 brominated epoxy resin and 20 parts by weight of NPPN-431glyoxal-type phenolic epoxy resin) was weighted, 50 parts by weight of phenol-type resin curing agent (from NAN YA, containing 25 parts by weight of NPEH-720H bisphenol-A-type phenolic resin, 15 parts by weight of NPEH-710H phenol-type phenolic resin and 10 parts by weight of BPNA benzaldehyde-type phenolic resin), and together with 1.7 parts by weight of 2-MI, dissolved in 242.3 parts by weight of acetone. Then the mixture was blended with Modified Filler A, as prepared previously, so as to obtain a liquid epoxy resin mixture.

A sheet of fiberglass cloth (from NAN YA, Model No. 7628) was impregnated in the liquid epoxy resin mixture, and then dried at 170° C. (in an impregnation machine) for a few minutes. The time for drying was well set to allow the minimum melt viscosity of the prepreg in the range between 2000 and 10000 poise. At last, the prepreg as a film was sandwiched by two 12 nm copper foils, and the combination was heated under a pressure of 30 kg/cm² and a starting temperature of 85° C. with a heating speed of 5° C./min until the temperature was increased to 185° C. Then the temperature was held for 120 minutes, before gradually cooled to 130° C. so as to obtain a copper substrate. The resulting copper substrate was measured for its physical properties, and the results together with the prepreg formula are listed in Table 1.

### Embodiment 2

0.3 parts by weight of sodium dimolybdate (Na₂Mo₂O₇.2H₂O) was used to treat 300 parts by weight of silicon dioxide (from Admatechs, Product Code SC2500) using the method as discussed for Embodiment 1, and the product is hereinafter referred to as Modified Filler B.

Modified Filler B was then blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Embodiment 3

0.3 parts by weight of ammonium metamolybdate ((NH₄)₂Mo₄O₁₃.4H₂O) was used to treat 300 parts by weight of silicon dioxide (from Admatechs, Product Code SC2500) using the method as discussed for Embodiment 1, and the product is hereinafter referred to as Modified Filler C.

Modified Filler C was then blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Embodiment 4

0.3 parts by weight of ammonium paramolybdate ((NH₄)₆Mo₇O₂₄.4H₂O) was used to treat 300 parts by weight of silicon dioxide (from Admatechs, Product Code SC2500) using the method as discussed for Embodiment 1, and the product is hereinafter referred to as Modified Filler D.

Modified Filler D was then blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Embodiment 5

1.5 parts by weight of ammonium paramolybdate ((NH₄)₆Mo₇O₂₄.4H₂O) was used to treat 300 parts by weight of silicon dioxide (from Admatechs, Product Code SC2500) using the method as discussed for Embodiment 1, and the product is hereinafter referred to as Modified Filler E.

Modified Filler E was then blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Embodiment 6

3.0 parts by weight of ammonium paramolybdate ((NH₄)₆Mo₇O₂₄.4H₂O) was used to treat 300 parts by weight of silicon dioxide (from Admatechs, Product Code SC2500) using the method as discussed for Embodiment 1, and the product is hereinafter referred to as Modified Filler F.

Modified Filler F was then blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Comparative Example 1

100 parts by weight of untreated silicon dioxide (from Admatechs, Product Code SC2500) was blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Comparative Example 2

3.0 parts by weight of ammonium paramolybdate ((NH₄)₆Mo₇O₂₄.4H₂O) and 300 parts by weight of untreated silicon dioxide (from Admatechs, Product Code SC2500) were blended with a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Comparative Example 3

3.0 parts by weight of a molybdenum zinc oxide/talcum powder mixture (supplied by Sherwin-Williams, Product Code Kemgard 911C) and 300 parts by weight of untreated silicon dioxide (from Admatechs, Product Code SC2500) were blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Comparative Example 4

300 parts by weight of refined silicon dioxide (Sibelco Bao Lin, Product Code G2C) was blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### Comparative Example 5

300 parts by weight of aluminum hydroxide (supplied by Showa Denko, Product Code H42M) was blended into a liquid epoxy resin mixture (formulated as that prepared in Embodiment 1), and a copper substrate was made as discussed for Embodiment 1. The resulting copper substrate was measured for its physical properties, and the results together with the prepreg formula are listed in Table 1.

### CONCLUSION

By comparing the results of Embodiments 1-6 to Comparative Examples 1-5 as listed in Table 1, the following findings are concluded:

1. Embodiment 1 through Embodiment 4 involve using different molybdenates at the same coating load to treat silicon dioxide (0.3 parts by weight for each 300 parts by weight of silicon dioxide), and making the molybdenate-coated silicon dioxide particles into laminates. Then a drill bit was used to drill 2,000 holes on one kind of the laminates and the drill bit's wear consumption after such drilling was measured as 36% (Embodiment 1), 38% (Embodiment 2), 35% (Embodiment 3) and 30% (Embodiment 4), respectively. On the other hand, the drill bit used to drill 2,000 holes on the laminate made of untreated silicon dioxide (Comparative Example 1) showed a wear consumption of 90%.

By comparison, all of the mentioned embodiments of the present invention performed much better in terms of drilling processability and drilling precision.

2. Embodiment 4 through Embodiment 6 involve using different coating loads of ammonium paramolybdate to treat 300 parts by weight of silicon dioxide. The coating loads used are 0.3 parts by weight (Embodiment 4), 1.5 parts by weight (Embodiment 5) and 3.0 parts by weight (Embodiment 6), respectively. With the increase of the coating load, the drilling processability and drilling precision were enhanced significantly. The drill bit's wear consumption levels are 30% (Embodiment 4), 21% (Embodiment 5) and 5% (Embodiment 6).

3. Embodiment 6 is different from Comparative Examples 2 and 3. Embodiment 6 involves using 3.0 parts by weight of ammonium paramolybdate to treat silicon dioxide, and Comparative Example 2 involves directly adding 3.0 parts by weight of ammonium paramolybdate and blending untreated silicon dioxide, while Comparative Example 3 involves directly adding 3.0 parts by weight of zinc molybdenum oxide/talcum powder mixture (911C) and blending untreated silicon dioxide.

By performing comparison in terms of drill bit's consumption and drilling precision, with the same content of molybdenate, the levels of drill bit's consumption can be rated as Embodiment 6 (5%) is excellent, Comparative Example 2 (68%) is inferior, Comparative Example 3 (83%) is worse, and the drilling precision can be rated as (Cpk value) Embodiment 6 (2.937) is excellent, Comparative Example 2 (1.735) is inferior and Comparative Example 3 (1.276) is worse. This is because that Embodiment 6, using the method of the present invention to treat silicon dioxide, had paramolybdate evenly coated over the surface of the silicon dioxide particles. Therefore, with the contents held the same, it provided better drilling processability and drilling precision.

4. In Comparative Example 2 and Comparative Example 3, although ammonium paramolybdate and molybdenum zinc oxide/talcum powdermixture (911C) were added, the blending was totally dependent on the mixing performed for preparing the formulas, and was unable to disperse the components evenly. Thus, Comparative Example 2 and Comparative Example 3 provided less improvement in terms of the laminates' hole-drilling performance. Embodiments 1 through 6 contributed to the most desirable Cpk values for drilling precision, between 2.0 and 3.2.

5. From the results of Embodiment 6 and Comparative Example 4, it is learned that Comparative Example 4 using refined silicon dioxide (G2C, Mohs hardness of 4-6) as the filler provides better drill bit's wear consumption (55%) as compared to a filler using normal silicon dioxide (Mohs hardness of 8, the resulting drill bit's wear consumption being 90%, as demonstrated in Comparative Example 1), but inferior to that of Embodiment 6 (the drill bit's wear consumption of 5%). Besides, Embodiment 6 presented a Z-axis coefficient of expansion of 81 ppm, much better than that of Comparative Example 4 (128 ppm).

6. From the results of Embodiment 6 and Comparative Example 5, it is learned that Comparative Example 5 using aluminum hydroxide (Mohs hardness of 3) as the filler provides better drill bit's wear consumption (46%) as compared to a filler using normal silicon dioxide (Mohs hardness of 8, the resulting drill bit's wear consumption being 90%, as demonstrated in Comparative Example 1), but inferior to that of Embodiment 6 (the drill bit's wear consumption of 5%). Besides, Embodiment 6 presented a Z-axis coefficient of expansion of 81 ppm, much better than that of Comparative Example 5 (143 ppm). In addition, the use of aluminum hydroxide is associated with moisture release during the test for solder heat resistance, which made the laminate performed poor in the test.

7. Comparative Example 2 involves directly adding 3.0 parts by weight of ammonium paramolybdate and blending untreated silicon dioxide, and Comparative Example 3 directly adding 3.0 parts by weight of molybdenum zinc oxide/talcum powder mixture (911C) and blending untreated silicon dioxide. Both of the Comparative Examples performed worse in terms of solder heat resistance as compared to Embodiments 1 through 6.

8. From the results it is learned that while the use of a filler with a lower Mohs hardness value (refined silicon dioxide or aluminum hydroxide) does help to improve the drill bit's wear consumption as compared to untreated silicon dioxide, this compromises the laminate's dimensional stability (coefficient of expansion) and solder heat resistance. Differently, the use of the silicon dioxide coated with the molybdenum compound as proposed by the present invention can preserve the laminate's desired physical properties and drilling processability, so the present invention is of industrial usability.

TABLE 1
Formulas and Physical Properties of Prepreg and Substrate for Embodiments
and Comparative Examples (unit: parts by weight)

| | | Item | | | | | | | | | | |
|---|---|---|---|---|---|---|---|---|---|---|---|---|
| | | Embodiment | | | | | | Comparative Example | | | | |
| | | 1 | 2 | 3 | 4 | 5 | 6 | 1 | 2 | 3 | 4 | 5 |
| | | Resin composition^{*1} | | | | | | | | | | |
| | | 100 parts by weight of epoxy resin (see Embodiment 1) | | | | | | | | | | |
| Modified filler | | 50 parts by weight of phenolic resin curing agent (see Embodiment 1) | | | | | | | | | | |
| A | Na₂MoO₄•2H₂O | 0.3 | — | — | — | — | — | — | — | — | — | — |
| | SiO₂ | 300 | | | | | | | | | | |
| B | Na₂Mo₂O₇•2H₂O | — | 0.3 | — | — | — | — | — | — | — | — | — |
| | SiO₂ | | 300 | | | | | | | | | |
| C | (NH₄)₂Mo₄O₁₃•4H₂O | — | — | 0.3 | — | — | — | — | — | — | — | — |
| | SiO₂ | | | 300 | | | | | | | | |
| D | (NH₄)₆Mo₇O₂₄•4H₂O | — | — | — | 0.3 | — | — | — | — | — | — | — |
| | SiO₂ | | | | 300 | | | | | | | |
| E | (NH₄)₆Mo₇O₂₄•4H₂O | — | — | — | — | 1.5 | — | — | — | — | — | — |
| | SiO₂ | | | | | 300 | | | | | | |
| F | (NH₄)₆Mo₇O₂₄•4H₂O | — | — | — | — | — | 3.0 | — | — | — | — | — |
| | SiO₂ | | | | | | 300 | | | | | |
| untreated silicon | | — | — | — | — | — | — | 300 | 300 | 300 | — | — |
| dioxide | | | | | | | | | | | | |
| ammonium | | — | — | — | — | — | — | — | 3*⁶ | — | — | — |
| paramolybdate | | | | | | | | | | | | |
| molybdenum zinc | | — | — | — | — | — | — | — | — | 3 | — | — |
| oxide/talcum powder | | | | | | | | | | | | |
| mixture (911C) | | | | | | | | | | | | |
| refined silicon | | — | — | — | — | — | — | — | — | — | 300 | — |
| dioxide (G2C) | | | | | | | | | | | | |
| aluminum hydroxide | | — | — | — | — | — | — | — | — | — | — | 300 |
| (H42M) | | | | | | | | | | | | |
| filler's Mohs | | 7 | 7 | 7 | 7 | 7 | 7 | 7 | 7 | 7 | 4~6 | 3 |
| hardness scale | | | | | | | | | | | | |
| drilling precision | | 2.338 | 2.337 | 2.382 | 2.383 | 2.511 | 2.937 | 1.191 | 1.735 | 1.276 | 1.831 | 1.918 |
| (Cpk value)*² | | | | | | | | | | | | |
| drill bit's wear | | 36 | 38 | 35 | 30 | 21 | 5 | 90 | 68 | 83 | 55 | 46 |
| consumption (%)*³ | | | | | | | | | | | | |
| images of worn drill | | Referred to Figure | | | | | | Referred to Figure | | | | |
| bits | | 2 | 3 | 4 | 5 | 6 | 7 | 8 | 9 | 10 | 11 | 12 |
| Coefficient | X-Y | 8.3 | 8.2 | 8.3 | 8.3 | 8.1 | 7.8 | 8.5 | 8.4 | 8.7 | 13.8 | 16.6 |
| of expansion | axis | | | | | | | | | | | |
| (ppm/° C.)*⁴ | Z axis | 82 | 83 | 82 | 82 | 83 | 81 | 84 | 83 | 85 | 128 | 143 |

| | | | | | | | | | | | |
|---|---|---|---|---|---|---|---|---|---|---|---|
| Solder heat | >600 | >600 | >600 | >600 | >600 | >600 | >600 | 305 | 380 | >600 | 141 |
| resistance (sec.)*⁵ | | | | | | | | | | | |

Note:
¹The unit of components for making up the formulas is part(s) by weight.
²The drill bit was used to drill 2,000 holes on a three-layered laminate having a thickness of 0.4 mmm, and then checked by an inspection device (supplied by NACHVISION, Model No. Hole-AOI ™ Epress) for the drilling precision (Cpk value). The higher the Cpk value is, the more precise the drilled hole is.
³Drill bit's wear consumption (%) = (A1-A2)/A1, where A1 represented an area of drill bit before used for drilling; A2 represented an area of drill bit after drilling;
⁴The coefficient of thermal expansion: The produced laminate was etched and had copper stripped. Then it was cut by a diamond cutter into pieces of 4(L)*4(W)*0.8(T)mm for having the laminate's coefficient of expansion be measured by using TMA (Thermomechanical Analysis). Therein, X-Y Axis denotes the fiberglass cloth's planar direction, and Z Axis denotes the substrate's thickness direction.
⁵288° C. solder heat resistance: the test piece was treated in a pressure vessel for 2 hours (at 121° C., under 2 atms). Then it was immersed into a 288° C. soldering pot to see the time it delaminated.
⁶The non-treated method involves directly adding 3.0 parts by weight of ammonium paramolybdate ((NH₄)₆Mo₇O₂₄•4H₂O) and blending untreated silicon dioxide.

What is claimed is:

1. An inorganic filler coated with molybdenum compound suited for making a laminate or a PCB having a low coefficient of thermal expansion, good heat tolerance, and excellent drilling processability, having a core-shell structural composition comprising an inorganic particle formed as a core and a molybdenum-compound coating formed as a shell covered over the inorganic particle, wherein the inorganic particle has a particle size between 0.01 and 50 μm in diameter, the molybdenum-compound coating contains a molybdenum compound having a coating load of 0.01 to 5 wt % of the inorganic filler, and the molybdenum compound is an ammonium phosphomolybdate or a crystal-water-containing molybdenate having a chemical formula (I) as follows:
xMe₂O.yMoO₃.nH₂O (I)
where,
Me is selected from the group consisting of sodium (Na), ammonium (NH₄), barium (Ba), ferrum (Fe), lead (Pb) and copper (Cu);
x:y=1:1; 1:2; 1:3; 1:4; 1:10; 1:16; 3:7; 3:8 or 5:12;
n is an positive integer from 1 to 10.

2. The inorganic filler of claim 1, wherein the molybdenum-compound coating contains a molybdenum compound of 0.1 to 3 wt % of the inorganic filler.

3. The inorganic filler of claim 1, wherein the inorganic particle formed as the core structure is one or more selected from the group consisting of silicon dioxide, titanium dioxide, aluminum hydroxide, magnesium hydroxide, calcium carbonate, aluminum oxide, magnesium oxide, talcum, aluminum nitride, boron nitride, silicon carbide, zinc oxide, zirconium oxide, quartz, diamond powder, diamond-like powder, graphite and calcined kaolin.

4. The inorganic filler of claim 1, wherein the inorganic particle formed as the core is a fumed silica having a particle size between 1 and 100 nm.

5. The inorganic filler of claim 1, wherein in General Formula (I) of the crystal-water-containing molybdenate, Me is sodium or ammonium.

6. A prepreg for use in making a printed circuit board, which composition comprises a resin mixture containing the inorganic filler of claim 1 in an amount of 20 to 80 wt % of the resin mixture.

7. A laminate for use in making a printed circuit board, which composition comprises a resin mixture containing the inorganic filler of claim 1 in an amount of 20 to 80 wt % of the resin mixture.
